(19) United States
(12) Patent Application Publication
(10) Pub. No.: US 2017/0099865 A1
(43) Pub. Date: Apr. 13, 2017

(54) Method for Enhancing Sauce Flavor

(71) Applicants: Jiangnan University, Wuxi City (CN); Guangdong Jiahao Food Company Ltd., Zhongshan City (CN); Nanjing Jianggao Drying Equipment Company Ltd., Nanjing City (CN)

(72) Inventors: Min Zhang, Wuxi City (CN); Ling Kong, Wuxi City (CN); Yaping Liu, Zhongshan City (CN); Weiming Zhang, Wuxi City (CN)

(21) Appl. No.: 15/089,763

(22) Filed: Apr. 4, 2016

(30) Foreign Application Priority Data
Oct. 10, 2015 (CN) 201510652990.1

(51) Int. Cl. A23L 27/21; A23L 29/231; A23L 15/00; A23L 27/24

(52) U.S. Cl. CPC A23L 27/21; A23L 27/24; A23L 29/231; A23L 15/00; A23V 2002/00

(57) ABSTRACT

A method for enhancing sauce flavor including steps of: collection, dilution, denaturation, enzymolysis, enzyme deactivation, centrifugation, secondary enzymolysis, deodorization, Maillard reaction, seasoning, dosing and flexible sterilization of a raw material, salted duck egg white. The by-product, salted duck egg white, not fully used in the food processing industry is recycled as a raw material, which not only saves the cost but also can protect the environment. Hydrolyzed animal protein is obtained through double-enzyme fractional hydrolysis. The degree of hydrolysis is high. The obtained hydrolyzed protein contains no trichloropropanol and is relatively safe, and flavourzyme decomposes bitter peptide, to make the hydrolysate not taste bitter. Some yeast, cooking wine and essence with unique flavor are chosen. Each ingredient is in a reasonable proportion, and the obtained product is delicious and of mellow flavor.

### CROSS-REFERENCE TO RELATED APPLICATION

This application claims priority to Chinese Patent Application No. 201510652990.1 filed Oct. 10, 2015, the disclosure of which is hereby incorporated in its entirety by reference.

### BACKGROUND

Technical Field

The present invention relates to a method for enhancing sauce flavor, which is achieved through recycling and double-enzyme fractional enzymolysis of a raw material, salted duck egg white, enhancement of sauce flavor through Maillard reaction, the formula of mellow flavor of the sauce and flexible sterilization that damages the quality of the sauce little, and belongs to the field of sauce processing technologies.

Related Art

In recent years, with rapid development of China's economy, continuous improvement of people's living standard and transformation of the concept of consumption, people have paid more and more attention to healthy diet and the richness of food, the seasoning develops towards convenience, nutrition, costliness, compound and diversification, and the trend is obvious. On the other hand, in recent years, China's catering industry has maintained strong growth momentum, and thus stimulates a significant increase in the purchase demand for the seasoning in the catering enterprises.

China is the world's superpower in duck breeding, the number of ducks and the number of duck eggs are in the first place of the world, and according to China's animal husbandry statistics yearbook 2008, the number of duck eggs in our country has more than 4.2 million tons. The salted egg white contains about 10%-11% of protein, the content of the salt is about 4%, and the rest is mainly water. The egg protein contains 8 kinds of amino acids and sulfur-containing amino acids essential for the human body, and is one kind of full-price high-quality protein of a higher biological value. The salted duck egg is one of the major egg products in our country, salted duck egg yolk is very popular because of its special texture and flavor, but salted egg white often becomes outcast due to no flavor and high salinity. Moreover, decomposition, fermentation and corruption of the salted egg white seriously s pollute surrounding environments and water sources. The egg white contains about 10% of high-quality protein, and the abandonment of the salted egg white is a great waste of protein resources. At present, there are some researches in recycling the salted duck egg white, but because the salted duck egg white has high sodium content, its development and utilization value is greatly limited. There are also some researches in desalinating the salted duck egg white and then applying the desalinated salted duck egg white to a variety of products, but because the desalting process will have higher energy loss, the salted duck egg white is still not widely used. Therefore, how to achieve full utilization of the salted egg white resources with more effective measures has gradually aroused people's concern.

At present, the raw material used to make this kind of flavor sauce is mainly seafood, etc., and its cost is high. Zhao Runji, Jin Yinxue, Shen Xuangui et. al, in 201110094117.7, Publication Number CN102232535A, disclose a new abalone—oyster sauce and a method for preparing the same, wherein abalone extract, oyster extract, seaweed extract and other ingredients are mixed with optimized proportions to produce a new abalone—oyster sauce. Although the flavor of the product is beautiful, because the costs of abalone and oyster are higher, the product can only go to the high-end sales market, and the applicability is limited. Zhu Cuibang, in Publication Number CN104273482A, discloses a method for producing a tasty juice with oyster sauce and golden pompano, and similarly, the material cost in the method is higher. Tang Hui, in Publication Number CN102389098A, discloses a method for producing a sea cucumber tasty juice with sea cucumber, pig's feet, chicken claw, mushroom and the like, Wang Guihong, Han Changke and Lv Gang, in Publication Number CN103099180A, disclose a method for producing a sauce with Short Necked Clam, and the methods all have a higher cost. However, in the present invention, recycling of the salted egg white not only can reduce the cost, but also can turn “waste” into wealth and save resources, thus having economic and social significance.

At present, the recycling of the salted duck egg white mainly focuses on desalinating and then making the salted duck egg white into various products. Feng Fengqin, Li Hengxing and DU Yongsheng, in Publication Number CN101032274A, disclose a method for making full use of salted duck egg white, the invention discloses a method for making full use of salted duck egg white, at first, digesting the salted egg white diluent with protease, and obtaining a clear liquid through centrifugation; then desalinating the clear liquid through nanofiltration and by adding deionized water constant-volume, to obtain an albumin peptide liquid and a percolate, and concentrating and spray-drying the albumin peptide liquid to obtain albumin peptide powder; next, vacuum-condensating the percolate at 50-60° C. to obtain a concentrated seasoning liquid; and finally, the precipitate is evenly mixed with flour, corn flour, milk powder, salad oil and the like for prilling to obtain pet food. Although the method of the invention can increase the utilization rate and the added value of the salted duck egg white to a greater extent, the procedure is more complicated, desalination is required in the middle thereof, the cost is higher, the removed salt will still cause a waste, and the economic value of the pet food finally made is not very high. However, the present invention does not require desalination, and the made product is the seasoning indispensable for people, which has a higher utilization value.

Zhang Min, Wang Yuchuan, Liu Yaping et. al, in Publication Number CN102599546A, disclose a method for preparing desalinated protein powder by efficiently desalinating and drying salted egg white, the invention, after filtering, mixing with water, ultrasonic, vacuum infiltration in conjunction with desalination, carries out cryogenic pulverization, microwave freeze-drying and negative-pressure microwave spray drying in conjunction with drying and superfine grinding technologies to make efficient and quality-guaranteed desalted superfine egg white powder, and applies the egg white powder to the production of high protein noodles. Although the invention makes the desalination rate of the salted egg white reach 95%-98% and the quality of the produced salted egg white powder is higher, the working procedure of the invention is complicated, has higher requirements for the device, and is difficult to implement in general small businesses. The present invention does not require desalination, has a simple process, does not require large devices, and can be achieved in general small businesses, and the utilization rate of the salted duck egg white is 100%.

Zhang Min, Zhou Bing, Chen Zhixiong et. al, in Publication Number CN103564396A, disclose a method for preparing odor-free delicious amino acid through acidolysis and enzymolysis of salted egg white, although compared with the method of single acidolysis or enzymolysis of animal-plant protein in the traditional technology, the method of combining acidolysis and enzymolysis in the invention can well control generation of harmful by-products and peculiar smell during acidolysis, the fat content of the salted egg white is about 0.25%, there is still a small amount of trichloropropanol produced during acidolysis, and in the subsequent preparation of a tasty juice, the residual strong acid may generate trichloropropanol with other ingredients, thus having a safety hazard. However, in the present invention, double-enzyme fractional hydrolysis is used, the enzymolysis condition is neutral or alkaline, it is impossible to generate trichloropropanol, and there is safety guarantee. Moreover, the final product of the invention 103564396A is delicious amino acid, which is only a semi-finished product, while the present invention introduces in detail enzymolysis of salted egg white, enhancing the flavor through Maillard reaction, and preparation of a tasty juice, which is a complete new product development, and the flavor of the product obtained after enhancement of the flavor through Maillard reaction is better than that of the semi-finished product published in CN103564396A.

Liu Jing, Liuping, Qi Xingpu et. al, in Publication Number CN104222989A, disclose a method for making sauce through enzymolysis of leftover bits and pieces of fresh water fishes and shrimps, including the following steps: selection of raw materials, cleaning, grinding, deodorization, disinfection, salinization, enzymolysis, enzyme deactivation, debittering, decoloration, separation, concentration, dosing, sterilization, and making a finished product. The invention uses fermentation and enzyme technologies to process leftover bits and pieces of fishes and shrimps into nutrient-rich fish sauce, which greatly increases the value of the leftover bits and pieces, reduces the waste and environmental pollution, meets the market's demand for high-grade seasoning, and has important economic and social significance. The process of the invention is similar to that of the present invention, and both have important economic and social significance, however, the difference is that the sterilization of the product in the invention is sterilization for 45 min at 116° C., such high thermization has a great destructive power for the flavor of the product, while the present invention uses radio-frequency flexible sterilization, and it is feasible to last 25 min in a 6 kW, 27.12 MHz radio-frequency sterilization device, which can preserve the prepared flavor of the product intactly.

Radio frequency is a kind of high frequency electromagnetic wave, the frequency range is 3 kHz-300 MHz, and the current internationally common RF frequencies are 13.56, 27.12 and 40.68 MHz. The radio frequency can penetrate into the material, cause the oscillation migration of charged ions inside the material, and convert electrical energy into heat energy, so as to achieve the purpose of heating. The radio frequency has a great penetration depth, heating uniformity is good, temperature control is stable, and the quality of the product can be better preserved. Sterilization applications of the radio frequency began in the 1970 s, Demeczky (1974) found upon study that the sealed package juice can have certain sterilization effects through radio frequency sterilization, and the quality after the sterilization is better than that of the fruit juice obtained through traditional sterilization. Wang Y (2003) carried out radio frequency treatment on macaroni and cheese, and the taste is better than the traditional sterilization method and the time of achieving a satisfactory sterilization effect is reduced by 1 h. Luechapattanaporn (2005) carried out radio frequency sterilization on scrambled eggs, and the results show that, compared with the traditional way of sterilization, the radio frequency sterilization can better keep the colour and lustre of the scrambled eggs. Qian Liu (2015) carried out radio frequency sterilization on vacuum packaged regulate vegetables, and found that radio frequency sterilization has little effects on the texture, the colour and lustre and the flavor of the vegetables. Therefore, the radio frequency sterilization is a sterilization method suitable for preserving the original product quality.

Sterilization on the sauce is generally the traditional pasteurization, however, because such thermal sterilization is greatly destructive to the flavor of the sauce, in recent years, lots of people are looking for new sterilization methods. Cheng Liping (2013) studied and compared the effects of ultra-high pressure sterilization and thermal sterilization on oat sauce, and the results show that the ultra-high pressure sterilization has fewer effects on the quality of the oat sauce than the thermal sterilization, but still has a certain impact. Zhang Jing (2010) compared high temperature and high pressure sterilization with pasteurization when choosing a sterilization manner for anchovy sauce, when the sterilization effects are the same, found that the higher the temperature, the greater the damage to sauce flavor, so the pasteurization with the lower sterilization temperature is chosen, but the pasteurization still has some effects on the quality of the sauce. Therefore, using radio frequency sterilization as one kind of flexible sterilization is one of the characteristics of the present invention.

### SUMMARY

An objective of the present invention is to provide a method for enhancing sauce flavor, so as to overcome the above shortcomings. Recycling of salted duck egg white has certain economic and social benefits, hydrolyzed animal protein that has a higher degree of hydrolysis, does not taste bitter and is of excellent flavor can be obtained by double-enzyme fractional enzymolysis on the salted egg white, after the Maillard reaction, the flavor of the protein hydrolysate can be enhanced, sugar, MSG, I+G, yeast, cooking wine, a thickening agent, pigment, essence and the like are added thereto, and finally, through radio-frequency flexible sterilization, the sauce with unique flavor, pure taste and good quality can be got.

In the technical solution of the present invention, abandoned salted duck egg white is recycled and double-enzyme fractional enzymolysis is carried out thereon, the Maillard reaction is controlled to enhance the flavor of the hydrolytic protein, a certain amount of ingredients are added for seasoning, and finally, radio-frequency flexible sterilization is carried out on the sauce to obtain the sauce product of which the flavor has been enhanced. A method for enhancing sauce flavor, comprising: collection, dilution, denaturation, enzymolysis, enzyme deactivation, centrifugation, secondary enzymolysis, deodorization, Maillard reaction, seasoning, dosing and flexible sterilization of a raw material, salted duck egg white; and comprising the following specific steps of:

(1) collection of a raw material, recovering salted duck egg white, to obtain a recovery liquid of the salted duck egg white;

(2) dilution: diluting the recovery liquid of the salted duck egg white obtained in step (1) 4-8 times with distilled water, to obtain a salted egg white diluent;

(3) denaturation: denaturing the salted egg white diluent obtained in step (2) for 10 min at 100° C., and then cooling the denatured salted egg white diluent;

(4) enzymolysis and enzyme deactivation: adjusting pH of the salted egg white diluent denatured in step (3) to 6-7 with citric acid and NaOH, adding papain which is 0.5%-4.5% of the mass of the salted duck egg white, and carrying out enzymolysis on the mixture for 2-5 h at 55-65° C., to obtain an enzymolysis solution; after the enzymolysis ends, keeping the obtained enzymolysis solution in boiling water for 10-30 min, and then immediately cooling the enzymolysis solution;

(5) centrifugation: centrifuging the enzymolysis solution obtained in step (4) for 10-30 min under 3000-5000 r/min, and taking supernatant to obtain an enzymolysis clear liquid;

(6) secondary enzymolysis: adding flavourzyme to the enzymolysis clear liquid obtained in step (5) according to 0.5%-3% of the mass of the salted duck egg white, of which the pH is adjusted to 5.0-7.0 with citric acid and NaOH, and carrying out enzymolysis for 2-4 h at the temperature of 40-60° C.; after the enzymolysis ends, keeping the enzymolysis solution in boiling water for 10-30 min, and then immediately cooling the enzymolysis solution, to obtain a final enzymolysis solution;

(7) deodorization: adding active carbon powder to the final enzymolysis solution obtained in step (6), wherein the adding amount is 2%-4% of the mass of the final enzymolysis solution, fully stirring the mixture, and filtering the mixture after 30-min adsorption, to obtain hydrolytic protein;

(8) Maillard reaction: adding xylose, glucose, glycine and thiamine which are respectively 0.04%-1%, 0.3%-0.9%, 0.2%-1% and 0.2%-1% of the mass of the hydrolytic protein to the hydrolytic protein obtained in step (7), and adjusting pH thereof to 3.0-7.0,for a 30-360-min reaction;

(9) seasoning and dosing: adding soy sauce, hydrolyzed vegetable protein, white granulated sugar, MSG, I+G, yeast and cooking wine which are respectively 10%-30%, 10%-20%, 2%-6%, 3%-7%, 0.2%-1%, 1%-3% and 0.5%-2.5% of the total weight of the sauce to the protein fluid after the Maillard reaction obtained in step (8); and as required, adding 0.3%-2% of a thickening agent, 0.2%-1% of the pigment and 1%-2% of the essence, to obtain the sauce; and

(10) flexible sterilization: sterilizing the sauce obtained in step (9) for 25 min in a 6 kW, 27.12 MHz radio-frequency sterilization device, to obtain the finished sauce.

The thickening agent in step (9) is selected as pectin or sodium alga acid.

The present invention has the following beneficial effects:

The present invention recycles the by-product, salted duck egg white, not fully used in the food processing industry as a raw material, which not only saves the cost but also can protect the environment, thus having important social and economical benefits.

The present invention obtains hydrolyzed animal protein through double-enzyme fractional hydrolysis, the degree of hydrolysis is high, the obtained hydrolyzed protein contains no trichloropropanol and is relatively safe, and flavourzyme decomposes bitter peptide, to make the hydrolysate not taste bitter.

The present invention chooses some yeast, cooking wine and essence with unique flavor, each ingredient is in a reasonable proportion, and the obtained product is delicious and of mellow flavor.

The present invention uses a radio-frequency sterilization technology, to cause the flavor of the sauce product to be better preserved.

### BRIEF DESCRIPTION OF THE DRAWINGS

FIG. 1 is a process flow chart of the present invention;

FIG. 2 is an analysis diagram of a prepared sauce GC; and

FIG. 3 is a self-made sauce flavor diagram and a result of electronic nose comparison with other two brand sauces.

### DETAILED DESCRIPTION

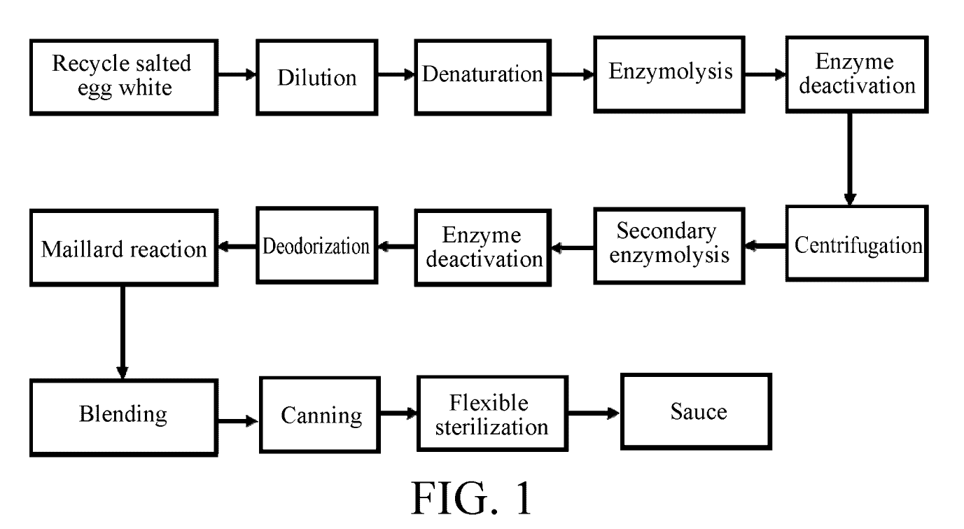

The present invention is further described below in combination with specific examples, and a specific process flow chart is as shown in FIG. 1.

### Embodiment 1

(1) collection of a raw material, recovering salted duck egg white, to obtain a recovery liquid of the salted duck egg white;

(2) dilution: diluting the recovery liquid of the salted duck egg white obtained in step (1) 5 times with distilled water, to obtain a salted egg white diluent;

(3) denaturation: denaturing the salted egg white diluent obtained in step (2) for 10 min at 100° C., and then cooling the denatured salted egg white diluent;

(4) enzymolysis and enzyme deactivation: adjusting pH of the salted egg white diluent denatured in step (3) to 6.0 with citric acid and NaOH, adding papain which is 2% of the mass of the salted duck egg white, and carrying out enzymolysis on the mixture for 3 h at 55° C., to obtain an enzymolysis solution; after the enzymolysis ends, keeping the obtained enzymolysis solution in boiling water for 10 min, and then immediately cooling the enzymolysis solution;

(5) centrifugation: centrifuging the enzymolysis solution obtained in step (4) for 25 min under 4500 r/min, and taking supernatant to obtain an enzymolysis clear liquid;

(6) secondary enzymolysis: adding flavourzyme to the enzymolysis clear liquid obtained in step (5) according to 1% of the mass of the salted duck egg white, of which the pH is adjusted to 7.0 with citric acid and NaOH, and carrying out enzymolysis for 2 h at the temperature of 50° C.; after the enzymolysis ends, keeping the enzymolysis solution in boiling water for 10 min, and then immediately cooling the enzymolysis solution, to obtain a final enzymolysis solution;

(7) deodorization: adding active carbon powder to the final enzymolysis solution obtained in step (6), wherein the adding amount is 4% of the mass of the final enzymolysis solution, fully stirring the mixture, and filtering the mixture after 30-min adsorption, to obtain hydrolytic protein;

(8) Maillard reaction: adding xylose, glucose, glycine and thiamine which are respectively 0.05%, 0.8%, 0.3% and 0.9% of the mass of the hydrolytic protein to the hydrolytic protein obtained in step (7), and adjusting pH thereof to 5.0, for a 4 h reaction;

(9) seasoning and dosing: adding soy sauce, hydrolyzed vegetable protein, white granulated sugar, MSG, I+G, yeast and cooking wine which are respectively 20%, 15%, 4%, 5%, 0.6%, 2.5% and 1.5% of the total weight of the sauce to the protein fluid after the Maillard reaction obtained in step (8); and as required, adding 1% of a thickening agent, 0.8% of the pigment and 2% of the essence, to obtain the sauce; and

(10) flexible sterilization: sterilizing the sauce obtained in step (9) for 25 min in a 6 kW, 27.12 MHz radio-frequency sterilization device, to obtain the finished sauce.

The degree of hydrolysis of the final product is about 56%, and the obtained sauce product has the color and luster, the smell and the taste specific to the sauce, does not have other bad smells, has harmonious aroma, and does not have peculiar smells and foreign matters.

### Embodiment 2

(1) collection of a raw material, recovering salted duck egg white, to obtain a recovery liquid of the salted duck egg white;

(2) dilution: diluting the recovery liquid of the salted duck egg white obtained in step (1) 4 times with distilled water, to obtain a salted egg white diluent;

(3) denaturation: denaturing the salted egg white diluent obtained in step (2) for 10 min at 100° C., and then cooling the denatured salted egg white diluent;

(4) enzymolysis and enzyme deactivation: adjusting pH of the salted egg white diluent denatured in step (3) to 6.0 with citric acid and NaOH, adding papain which is 2.5% of the mass of the salted duck egg white, and carrying out enzymolysis on the mixture for 4 h at 60° C., to obtain an enzymolysis solution; after the enzymolysis ends, keeping the obtained enzymolysis solution in boiling water for 10 min, and then immediately cooling the enzymolysis solution;

(5) centrifugation: centrifuging the enzymolysis solution obtained in step (4) for 20 min under 4500 r/min, and taking supernatant to obtain an enzymolysis clear liquid;

(6) secondary enzymolysis: adding flavourzyme to the enzymolysis clear liquid obtained in step (5) according to 0.8% of the mass of the salted duck egg white, of which the pH is adjusted to 6.5 with citric acid and NaOH, and carrying out enzymolysis for 3 h at the temperature of 55° C.; after the enzymolysis ends, keeping the enzymolysis solution in boiling water for 10 min, and then immediately cooling the enzymolysis solution, to obtain a final enzymolysis solution;

(7) deodorization: adding active carbon powder to the final enzymolysis solution obtained in step (6), wherein the adding amount is 4% of the mass of the final enzymolysis solution, fully stirring the mixture, and filtering the mixture after 30-min adsorption, to obtain hydrolytic protein;

(8) Maillard reaction: adding xylose, glucose, glycine and thiamine which are respectively 0.06%, 0.7%, 0.4% and 0.8% of the mass of the hydrolytic protein to the hydrolytic protein obtained in step (7), and adjusting pH thereof to 6.0, for a 3.5 h reaction;

(9) seasoning and dosing: adding soy sauce, hydrolyzed vegetable protein, white granulated sugar, MSG, I+G, yeast and cooking wine which are respectively 20%, 15%, 4%, 5%, 0.6%, 2.5% and 1.5% of the total weight of the sauce to the protein fluid after the Maillard reaction obtained in step (8); and as required, adding 1% of a thickening agent, 0.8% of the pigment and 2% of the essence, to obtain the sauce; and

(10) flexible sterilization: sterilizing the sauce obtained in step (9) for 25 min in a 6 kW, 27.12 MHz radio-frequency sterilization device, to obtain the finished sauce.

The degree of hydrolysis of the final product is about 54%, and the obtained sauce product has the color and luster, the smell and the taste specific to the sauce, does not have other bad smells, has harmonious aroma, and does not have peculiar smells and foreign matters.

### Embodiment 3

(1) collection of a raw material, recovering salted duck egg white, to obtain a recovery liquid of the salted duck egg white;

(2) dilution: diluting the recovery liquid of the salted duck egg white obtained in step (1) 6 times with distilled water, to obtain a salted egg white diluent;

(3) denaturation: denaturing the salted egg white diluent obtained in step (2) for 10 min at 100° C., and then cooling the denatured salted egg white diluent;

(4) enzymolysis and enzyme deactivation: adjusting pH of the salted egg white diluent denatured in step (3) to 6.5 with citric acid and NaOH, adding papain which is 4% of the mass of the salted duck egg white, and carrying out enzymolysis on the mixture for 4 h at 65° C., to obtain an enzymolysis solution; after the enzymolysis ends, keeping the obtained enzymolysis solution in boiling water for 10 min, and then immediately cooling the enzymolysis solution;

(5) centrifugation: centrifuging the enzymolysis solution obtained in step (4) for 25 min under 4500 r/min, and taking supernatant to obtain an enzymolysis clear liquid;

(6) secondary enzymolysis: adding flavourzyme to the enzymolysis clear liquid obtained in step (5) according to 2% of the mass of the salted duck egg white, of which the pH is adjusted to 7.0 with citric acid and NaOH, and carrying out enzymolysis for 4 h at the temperature of 60° C.; after the enzymolysis ends, keeping the enzymolysis solution in boiling water for 10 min, and then immediately cooling the enzymolysis solution, to obtain a final enzymolysis solution;

(7) deodorization: adding active carbon powder to the final enzymolysis solution obtained in step (6), wherein the adding amount is 3% of the mass of the final enzymolysis solution, fully stirring the mixture, and filtering the mixture after 30-min adsorption, to obtain hydrolytic protein;

(8) Maillard reaction: adding xylose, glucose, glycine and thiamine which are respectively 0.07%, 0.4%, 0.6% and 0.5% of the mass of the hydrolytic protein to the hydrolytic protein obtained in step (7), and adjusting pH thereof to 6.0, for a 3 h reaction;

(9) seasoning and dosing: adding soy sauce, hydrolyzed vegetable protein, white granulated sugar, MSG, I+G, yeast and cooking wine which are respectively 20%, 15%, 4%, 5%, 0.6%, 2.5% and 1.5% of the total weight of the sauce to the protein fluid after the Maillard reaction obtained in step (8); and as required, adding 1% of a thickening agent, 0.8% of the pigment and 2% of the essence, to obtain the sauce; and

(10) flexible sterilization: sterilizing the sauce obtained in step (9) for 25 min in a 6 kW, 27.12 MHz radio-frequency sterilization device, to obtain the finished sauce.

The degree of hydrolysis of the final product is about 54%, and the obtained sauce product has the color and luster, the smell and the taste specific to the sauce, does not have other bad smells, has harmonious aroma, and does not have peculiar smells and foreign matters.

The degree of hydrolysis of the final product is about 58%, and the obtained sauce product has the color and luster, the smell and the taste specific to the sauce, does not have other bad smells, has harmonious aroma, and does not have peculiar smells and foreign matters.

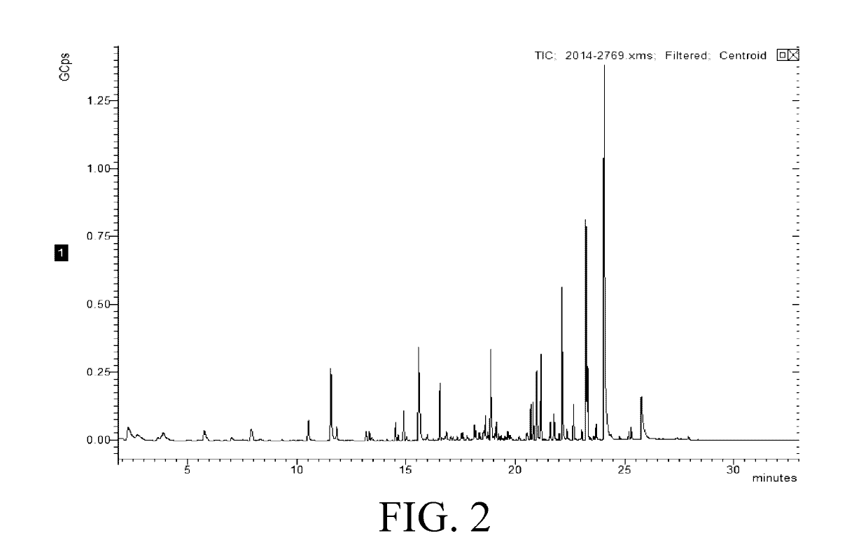

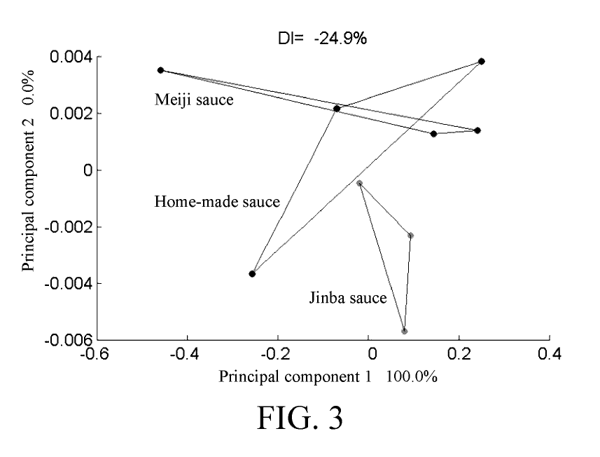

The analysis diagram of the prepared sauce GC is as shown in FIG. 2; the made sauce flavor diagram and the result of electronic nose comparison with other two brand sauces are as shown in FIG. 3.

What is claimed is:

1. A method for enhancing sauce flavor, comprising:
(1) collection of a raw material, recovering salted duck egg white, to obtain a recovery liquid of the salted duck egg white;
(2) diluting the recovery liquid of the salted duck egg white obtained in step (1) 4-8 times with distilled water, to obtain a salted egg white diluent;
(3) denaturing the salted egg white diluent obtained in step (2) for 10 min at 100° C., and then cooling the denatured salted egg white diluent;
(4) adjusting pH of the salted egg white diluent denatured in step (3) to 6-7 with citric acid and NaOH, adding papain which is 0.5%-4.5% of the mass of the salted duck egg white, and carrying out enzymolysis on the mixture for 2-5 h at 55-65° C., to obtain an enzymolysis solution; after the enzymolysis ends, keeping the obtained enzymolysis solution in boiling water for 10-30 min, and then immediately cooling the enzymolysis solution;
(5) centrifuging the enzymolysis solution obtained in step (4) for 10-30 min under 3000-5000 r/min, and taking supernatant to obtain an enzymolysis clear liquid;
(6) adding flavourzyme to the enzymolysis clear liquid obtained in step (5) according to 0.5%-3% of the mass of the salted duck egg white, of which the pH is adjusted to 5.0-7.0 with citric acid and NaOH, and carrying out enzymolysis for 2-4 h at the temperature of 40-60° C.; after the enzymolysis ends, keeping the enzymolysis solution in boiling water for 10-30 min, and then immediately cooling the enzymolysis solution, to obtain a final enzymolysis solution;
(7) adding active carbon powder to the final enzymolysis solution obtained in step (6), wherein the adding amount is 2%-4% of the mass of the final enzymolysis solution, fully stirring the mixture, and filtering the mixture after 30-min adsorption, to obtain hydrolytic protein;
(8) adding xylose, glucose, glycine and thiamine which are respectively 0.04%-1%, 0.3%-0.9%, 0.2%-1% and 0.2%-1% of the mass of the hydrolytic protein to the hydrolytic protein obtained in step (7), and adjusting pH thereof to 3.0-7.0, for a 30-360-min reaction;
(9) adding soy sauce, hydrolyzed vegetable protein, white granulated sugar, MSG, I+G, yeast and cooking wine which are respectively 10%-30%, 10%-20%, 2%-6%, 3%-7%, 0.2%-1%, 1%-3% and 0.5%-2.5% of the total weight of the sauce to the protein fluid after the Maillard reaction obtained in step (8); and as required, adding 0.3%-2% of a thickening agent, 0.2%-1% of the pigment and 1%-2% of the essence, to obtain the sauce; and
(10) sterilizing the sauce obtained in step (9) for 25 min in a 6 kW, 27.12 MHz radio-frequency sterilization device, to obtain the finished sauce.

2. The method for enhancing sauce flavor according to claim 1, wherein the thickening agent in step (9) is pectin or sodium alga acid.
